(19) United States
(12) Patent Application Publication
(10) Pub. No.: US 2009/0143266 A1
(43) Pub. Date: Jun. 4, 2009

(54) DETERGENT COMPOSITION

(76) Inventors: Fabrizio Meli, Tynemouth (GB); Ricardo Garcia de Alba, Sandyford (GB); Jose Maria Velazquez, Ponteland (GB)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/364,695

(22) Filed: Feb. 3, 2009

Related U.S. Application Data
(63) Continuation of application No. 11/640,715, filed on Dec. 18, 2006.
Application No. 11/640,715 is a continuation of application No. 11/447,427, filed on Jun. 6, 2006, now abandoned.
Application No. 11/447,427 is a continuation of application No. 11/298,224, filed on Dec. 9, 2005, now abandoned.

(30) Foreign Application Priority Data
Aug. 7, 2002 (EP) 02255450.3

(51) Int. Cl. C11D 3/50

(52) U.S. Cl. 510/101; 510/513; 510/276; 512/4

(57) ABSTRACT

A laundry additive composition comprising one or more perfume components in slow release form and wherein the release kinetics are controlled so as to provide a fabric delivery index of at least 0.3.

### CROSS-REFERENCE

This application is a continuation of and claims priority under 35 U.S.C. §120 to U.S. application Ser. No. 11/640,715, filed Dec. 18, 2006, which in turn is a continuation of and claims priority under 35 U.S.C. §120 to U.S. application Ser. No. 11/447,427, filed Jun. 6, 2006, (now abandoned), which in turn is a continuation of and claims priority under 35 U.S.C. §120 to U.S. application Ser. No. 11/298,224, filed Dec. 9, 2005, (now abandoned), which in turn claims priority under 35 U.S.C. §120 to U.S. application Ser. No. 10/635,186, filed Aug. 6, 2003, (now abandoned), which claims priority under 35 U.S.C. §119(a)-(d) or §365(b) to European Application Serial Number 02255540.3, filed Aug. 7, 2002.

### FIELD OF THE INVENTION

The present invention relates to solid compositions comprising a perfume, especially solid laundry detergent compositions comprising a perfume.

### BACKGROUND TO THE INVENTION

Laundry detergent products typically comprise a perfume. The function of this perfume is to mask the undesirable odour of the detergent components in the product and to ensure that the detergent has a desirable smell that consumers find appealing throughout the duration of a laundering process; this includes during dispensing of the product (neat product odour), and during the washing and drying stages (wet fabric odour) of the laundering process. In addition, it is also desirable for the perfume to give the recently laundered dry fabric a pleasant odour (dry fabric odour).

Perfumers attempt to meet the demanding consumer need of having a laundry detergent product that delivers good neat product odour, good wet fabric odour and good dry fabric odour performance, by formulating perfumes that comprise several perfume components that are designed to deliver a specific odour at a specific stage in the laundering process. However, it is difficult to formulate a perfume that is capable of adequately delivering the desired odour during the desired stage in the laundering process, and which does not affect the performance of the other perfume components in the perfume. This is due to the unwanted early release (i.e. leakage) of fragrance from perfume components, which affects the performance of other perfume components that are designed to deliver a perfume odour during earlier stages of the laundering process.

Perfumers have attempted to overcome this problem by designing a perfume containing composition, which comprises perfume components that are compatible with each other and deliver fragrances that are compatible with the fragrances that are delivered by the other perfume components, in order to negate the effect that any leakage of one perfume component fragrance may have on another perfume component fragrance. However, in order to achieve this fragrance compatibility, perfumers have had to formulate very complex and costly perfumes having very limited choice in which perfume raw materials they can choose when formulating a perfume containing composition or component thereof.

### SUMMARY OF THE INVENTION

The present invention overcomes this problem by providing a laundry additive composition comprising one or more perfume components in slow release form and wherein the release kinetics are controlled so as to provide a fabric delivery index of at least 0.3. The fabric delivery index=

the concentration of perfume component in the headspace of dry fabric
the concentration of perfume component in the headspace of wet fabric

A further embodiment of the present invention provides a laundry detergent composition comprising the above laundry additive composition.

A further embodiment of the present invention provides a process for preparing a perfume particle, the process comprises the steps of: (a) contacting a perfume with a porous carrier material, to form a perfume-loaded material; and (b) contacting the perfume-loaded material with an aqueous solution or dispersion of encapsulating material, to form an intermediate mixture; and (c) drying the intermediate mixture to form a perfume particle; wherein, the perfume-loaded material is in contact with the aqueous mixture of encapsulating material for a period of time of less than 120 minutes, prior to drying.

### DETAILED DESCRIPTION OF THE INVENTION

### Perfume Component

The perfume component typically comprises one or more perfume raw materials (PRMs), more typically the perfume component comprises at least two, or at least five or even at least 10 or more PRMs, which are typically blended together to obtain a perfume accord that has a particular desired odour. The perfume component comprises all of the PRMs that share the same method of incorporation. For example, all of the PRMs that are delivered by a spray-on delivery system form one perfume component (e.g. form a spray-on perfume component). The perfume component is typically a selection of PRMs that are blended together to obtain a particular perfume accord such as a fruity perfume accord. Typical PRMs suitable for use are selected from the group consisting of aldehydes, ketones, esters, alcohols, propionates, salicylates, ethers and combinations thereof. Typically, the PRMs are liquid, especially at ambient temperature and pressure. Usually, the PRMs are synthetic molecules. Alternatively, the PRMs can be derived from animals or plants. The perfume component can be formulated to provide any olfactory perception that is desired. For example, the perfume component can be a light floral fragrance a fruity fragrance or a woody or earthy fragrance. The perfume component may be of a simple design and comprise only a relatively small number of PRMs, or alternatively the perfume component may be of a more complex design and comprise a relatively large number of PRMs. Preferred perfume components and PRMs are described in more detail in WO 97/11151, especially from page 8, line 18 to page 11, line 25, which is herein incorporated by reference.

The perfume component typically has a threshold olfactory detection level, otherwise known as an odour detection threshold (ODT) of less than or equal to 3 ppm, more preferably equal to or less than 10 ppb. Typically, the perfume component comprises PRMs that have an ODT of less than or equal to 3 ppm, more, preferably equal to or less than 10 ppb. Preferred is when at least 70 wt %, more preferably at least 85 wt %, of the PRMs that are comprised by the perfume component have an ODT of less than or equal to 3 ppm, more preferably equal to or less than 10 ppb. A method of calculating ODT is described in WO 97/11151, especially from page 12, line 10 to page 13, line 4, which is herein incorporated by reference.

Typically, the perfume component has a boiling point of less than 300° C. Typically, the perfume component comprises at least 50 wt %, more preferably at least 75 wt %, of PRMs that have a boiling point of less than 300° C. In addition, the perfume component has an octanol/water partition coefficient (ClogP) value greater than 1.0. A method of calculating ClogP is described in WO 97/11151, especially from page 11, line 27 to page 12, line 8, which is herein incorporated by reference.

The perfume component can be contained in a particle, and is typically adsorbed or absorbed onto a porous carrier material. The porous carrier and adsorption/absorption process is described in more detail below. Perfume components that are adsorbed/absorbed onto porous carriers can be tailored in such a way to delay the release of the perfume component from the porous carrier.

One means of tailoring a perfume component to be released slowly from a porous carrier material is to ensure that the perfume component comprises one or more perfume raw materials that have good affinity for the porous carrier material. For example, PRMs that have a specific size, shape (i.e. a molecular cross-sectional area and molecular volume), and surface area relative to the pores of the porous carrier material exhibit improved affinity for the porous carrier material, and are able to prevent other PRMs that have less affinity to the porous carrier material, from leaving the porous carrier material during the washing and rinsing stage of the laundering process. This is described in more detail in WO 97/11152, especially from page 7, line 26 to page 8, line 17, which is herein incorporated by reference.

Other means of tailoring a perfume component to be released slowly from a porous carrier material is to ensure that the perfume component comprises PRMs that are small enough to pass through the pores of the carrier material, and that are capable of reacting together, or with a small non-perfume molecule (otherwise known as a size-enlarging agent) to form a larger molecule (other wise known as a release inhibitor) that is too large to pass through the pores of the carrier. The release inhibitor, being too large to pass through the pores of the porous carrier material, becomes entrapped within the porous carrier material until it breaks down (i.e. hydrolyses) back to the smaller PRM and size enlarging agent, which are then able to pass through the pores of, and exit, the porous carrier material. Typically, this is achieved by the formation of hydrolysable bonds between small PRMs and the size-enlarging agent, to form a release inhibitor within the porous carrier material. Upon hydrolysis, the small PRMs are released from the larger molecule and are able to exit the porous carrier material. This is described in more detail in WO 97/34981, especially from page 7, line 4 to page 5, line 14, which is herein incorporated by reference.

In addition, the above approach of forming a release inhibitor by reacting a PRM with a size-enlarging agent can be further adapted by using a size enlarging agent that has a hydrophilic portion and a hydrophobic portion (e.g. sugar based non-ionic surfactants, such as lactic acid esters of C₁₈ monoglycerides). This is described in more detail in WO 97/34982, especially from page 6, line 27 to page 7, line 17, which is herein incorporated by reference.

The perfume component can be a starch encapsulated perfume accord or another type of perfume component having controlled release kinetics. And one or more perfume components can be present in the composition. However, it is essential that at least one perfume components is in slow release form and the release kinetics are controlled so as to provide a fabric delivery index of at least 0.3, preferably at least 0.5 or even at least 0.7.

### Perfume Particle

Typically, the perfume component is contained in a perfume particle. The perfume particle is used to give a dry fabric odour benefit to a fabric. The perfume particle comprises a perfume component in slow release form, wherein the release kinetics are controlled so as to provide a fabric delivery index of at least 0.3, preferably at least 0.5 or at least 0.7 and may even be from 0.7 to 1.0. The perfume particle may also comprise a porous carrier material. The porous carrier material is described in more detail below. The perfume component in the perfume particle is typically at least partially encapsulated, preferably completely encapsulated with an encapsulating material. The encapsulating material is described in more detail below. Typically, the perfume component is absorbed and/or adsorbed onto the porous carrier to form a perfume-loaded material, and the perfume-loaded material is then at least partially encapsulated, preferably completely encapsulated with the encapsulating material to form a perfume particle. The process of preparing the perfume particle is described in more detail below.

The perfume particle may be coated. Preferred coating means are described in WO 98/12291 and WO 98/42818, which are herein incorporated by reference.

Typically, the perfume particle is a glassy particle and preferably has a hygroscopicity value of less than 80%. The hygroscopicity value is the level of moisture uptake by the perfume particle, as measured by a weight percent increase in the weight of the perfume particle. The hygroscopicity value and a method for measuring it are described in more detail in WO 97/11151, especially from page 7, line 11 to page 7, line 20, which is incorporated herein by reference.

The perfume particle typically comprises from 3% to 50% preferably from 5% to 20%, by weight of the perfume particle, of perfume component. The perfume particle may comprise from 15% to 80%, preferably from 20% to 65%, by weight of the perfume particle, of encapsulating material. The perfume particle may comprise other adjunct components, although preferably the perfume particle comprises essentially only of perfume component, porous carrier, encapsulating material and water.

### Porous Carrier Material

The porous carrier material can be any porous material that is capable of supporting (e.g. by absorption or adsorption) the perfume component. Typically, the porous carrier material is substantially water-insoluble. Preferred porous carrier materials are selected from the group consisting of amorphous silicates, crystalline non-layered silicates, calcium carbonates, calcium/sodium carbonate double salts, sodium carbonates, clays, aluminosilicates, chitin micro beads, cyclodextrins, and combinations thereof. More preferably, the porous carrier material is an aluminosilicate, most preferably a zeolite, especially a faujustite zeolite, such as zeolite X, zeolite Y and combinations thereof. An especially preferred porous carrier is zeolite 13x. Preferred aluminosilicates are described in more detail in WO 97/11151, especially from page 13, line 26 to page 15, line 2, which is herein incorporated by reference.

It may be preferred for the porous carrier to have a crystalline structure and to have a primary crystal size of 20 microns or bigger. Larger primary particle sized porous carriers are more likely to become entrapped onto fabric during the washing stage of the laundering process, and thus show improved fabric deposition. Porous carriers having a primary crystal size of 20 microns or greater, show improved dry fabric odour performance, believed to be due to improved fabric deposition. However, porous carrier materials having a smaller primary crystal size, e.g. from 0.01 to 7 microns or even to 5 microns, are more readily commercially available and can be used in accordance with the present invention. The larger primary crystal sizes are especially preferred when the porous carrier is an aluminosilicate, especially a zeolite X and/or Y.

### Encapsulating Material

The encapsulating material typically encapsulates at least part, preferably all, of the perfume component and, if present, the porous carrier material. Typically, the encapsulating material is water-soluble and/or water-dispersible. The encapsulating material may have a glass transition temperature (Tg) of 0° C. or higher. Glass transition temperature is described in more detail in WO 97/11151, especially from page 6, line 25 to page 7, line 2, which is incorporated herein by reference.

The encapsulating material is preferably selected from the group consisting of carbohydrates, natural or synthetic gums, chitin and chitosan, cellulose and cellulose derivatives, silicates, phosphates, borates, polyvinyl alcohol, polyethylene glycol, and combinations thereof. Preferably the encapsulating material is a carbohydrate, typically selected from the group consisting of monosaccharides, oligosaccharides, polysaccharides, and combinations thereof. Most preferably, the encapsulating material is a starch. Preferred starches are described in EP 0 922 499; U.S. Pat. No. 4,977,252; U.S. Pat. No. 5,354,559; and U.S. Pat. No. 5,935,826.

### Fabric Delivery Index

The fabric delivery index is a measure of how much of the perfume component is released from the dry fabric and how much is released from the wet fabric. The fabric delivery index is a ratio of the concentration of perfume component in the headspace of dry fabric: concentration of perfume component in the headspace of wet fabric, and is represented by the following:

the concentration of perfume component in the headspace of dry fabric
the concentration of perfume component in the headspace of wet fabric.
At least one perfume component is in slow release form, wherein the release kinetics are controlled so as to provide a fabric delivery index of at least 0.3, preferably at least 0.5 and most preferably at least 0.7. It may be preferred that the fabric delivery index is from 0.7 to 1.0.

Typically, the concentration of perfume component in the headspace of dry fabric is determined by the following method: The perfume component is added to detergent adjunct components to make the following solid granular composition: 0.1 wt % perfume component, 7.5 wt % sodium linear C₁₁₋₁₃ alkyl benzene sulphonate, 3.5 wt % linear C₁₂₋₁₄ linear primary alcohol condensed with an average of 7 moles of ethylene oxide per mole of alcohol, 1 wt % cationic surfactant of the formula: RN⁺(CH₃)₂(C₂H₄OH) wherein R═C₁₂₋₁₄ linear alkyl chain, 20% anhydrous sodium tripolyphosphate, 20 wt % sodium carbonate, 3 wt % sodium silicate, 6 wt % moisture, to 38.9 wt % sodium sulphate. At least 121.5 g of the solid granular composition is left in storage for 14 days at ambient temperature, pressure and relative humidity in closed glass container.

After 14 days storage, 24 10 cm square terry towel cloths are placed in an automatic washing machine (Miele Novotronic W918) along with an equal weight of terry towel material to act as the ballast during the laundering process. 121.5 g of the solid granular composition is added to the dispensing draw of the automatic washing machine, and the terry towel cloths undergo a washing programme at 40° C. (40° C., short wash, minimum iron, 1,000 rpm spin) with a main wash cycle of 20 a minutes and 4 rinse cycles lasting a total of 20 minutes.

After the washing stage, 12 of the terry towel cloths (wet terry towel cloth) are then analysed and the concentration of the perfume component in the headspace of the wet fabric is determined. This is described in more detail below. The remaining 12 terry towel cloths are dried using an automatic drier (Miele Dryer Machine Novotronic T640) for a first drying stage of 40 minutes at normal temperature settings (80° C.) and a second drying stage of 20 minutes at warm (50° C.) temperature settings. The 12 terry towel cloths are left to cool for one hour (dry terry towel cloths) and are then analysed and the concentration of the perfume component in the headspace of the dry fabric is determined. This is described in more detail below.

The concentration of the perfume component in the headspace of the wet and dry fabric, respectively, is determined by the following method. The terry towel cloth is placed in a sealed glass container containing a polydimethyl siloxane (PDMS) Twister Gerstel™ Bar of 0.5 mm thickness and 20 mm length. The bar, which is never in direct physical contact with the fabric, is exposed to wet terry towel cloths for 3 hours and to dry terry cloths for 15 hours, respectively. The bar is then transferred to an autodesorp glass lined stainless steel tube (GLT) of a Gas Chromatography Agilent 6890™ with MS detector 5973™. The GLT is placed in the autodesorb carrousel for injection. Gas chromatography is then carried out and the concentration of the perfume component (in the headspace of the fabric) is determined.

### Composition

The laundry additive composition is typically a solid composition, preferably a solid particulate composition. The composition is used to give a dry fabric odour benefit to a fabric. It is a laundry additive or auxiliary composition and can be used separately from any other fabric treatment composition or, alternatively, can be contained in a laundry detergent composition. Typically, the laundry additive composition is contained in a laundry detergent composition. The laundry additive composition, and more preferably the laundry detergent composition may optionally comprise adjunct components, typically laundry detergent adjunct components. These adjunct components are described in more detail below. The composition may be the product of a spray-dry and/or agglomeration process. A preferred process for preparing the perfume component is described in more detail below.

The laundry additive composition comprises one or more perfume components in slow release form. The perfume component is described in more detail above. The composition comprises at least one perfume component in slow release form, wherein the release kinetics are that has a fabric delivery index of at least 0.3, preferably at least 0.5, or even at least 0.7. The perfume component may have a fabric delivery index of from 0.7 to 1.0.

The laundry additive composition may also additionally comprise at least one perfume component of a different composition and olfactory character having a fabric delivery index for dry versus wet fabrics of less than 0.1, preferably less 0.05, more preferably less than 0.01. This further allows the delivery of different olfactory characters to wet and dry fabric, respectively, and negates the need to ensure that the two different perfume components have compatible fragrances.

The composition comprises from 0% to 26%, by weight of the composition, of phosphate. Preferably, the composition comprises 0%, by weight of the composition, of phosphate. Typically, the composition is free from deliberately added phosphate.

### Adjunct Components

The composition may optionally comprise adjunct components, preferably laundry detergent adjunct components. These adjunct components are typically selected from the group consisting of detersive surfactants, builders, polymeric co-builders, bleach, chelants, enzymes, anti-redeposition polymers, soil release polymers, polymeric soil dispersing and/or suspending agents, dye transfer inhibitors, fabric integrity agents, brighteners, suds suppressors, fabric softeners, flocculants, and combinations thereof. Suitable adjunct components are described in more detail in WO 97/11151, especially from page 15, line 31 to page 50, line 4, which is incorporated herein by reference.

### Process for Preparing the Perfume Particle

The perfume particle is obtained by a process comprising the steps of: (a) contacting a perfume component with a porous carrier material, to form a perfume-loaded material; and (b) contacting the perfume-loaded material with an aqueous solution or dispersion of encapsulating material, to form an intermediate mixture; and (c) drying the intermediate mixture to form a perfume particle. The perfume-loaded material is in contact with the aqueous mixture of encapsulating material for a period of time of less than 120 minutes, preferably less than 90 minutes, even more preferably less than 60 minutes, and most preferably less than 30 minutes or even less than 20 minutes, prior to drying. It may even be preferred that the perfume-loaded material is in contact with the aqueous mixture of encapsulating material for a period of time of from 0.001 minutes to 20 minutes, or even from 10 minutes to 20 minutes, prior to drying. The less time that the perfume loaded material is in contact with the aqueous mixture of encapsulating material, then the less leakage of PRMs from the porous carrier material occurs. This results in the formation of perfume particle that has a higher fabric delivery index and gives an improved fabric odour benefit during the laundering process. However, this period of time still needs to be long enough to ensure that adequate encapsulation of the perfume component and porous carrier occurs.

The first step, step (a), of contacting a perfume component to with a porous carrier material to form a perfume-loaded material can occur in any suitable mixing vessel. Typically, step (a) is carried out in an Schugi, or other high shear mixer, for example a CB mixer, although other lower shear mixers, such as a KM mixer, may also be used. Typically, the porous carrier material is passed through the high shear mixer and the perfume component is sprayed onto the porous carrier material. The adsorption of perfume component onto the porous carrier material is typically an exothermic reaction and heat may be generated during this stage of the process (depending on the PRMs and porous carrier material used). When the porous carrier material is an aluminosilicate such as zeolite 13x, then a substantial amount of heat can be generated during step (a). The generation of heat can be controlled by any suitable heat management means; such as placing water jackets or coils on the mixer or other vessel used in step (a), or by direct cooling, for example by using liquid nitrogen, to remove the heat that is generated, and/or by controlling the flow rate of the porous carrier material and perfume component in the mixer or other vessel used in step (a) to prevent the build up of an excess amount of heat during step (a). The build up of heat during step (a) is more likely to occur and be a problem when the process is a continuous process.

The second step, step (b), of contacting the perfume-loaded material with an aqueous solution or dispersion of encapsulating material to form an intermediate mixture, can occur in any suitable vessel such as a stirred tank. Alternatively, step (b) can occur in an online mixer. The stirring tank can be a batch tank or a continuous tank. As described above, the time that the perfume-loaded material is in contact with the aqueous mixture of encapsulating material needs to be carefully controlled in order to obtain a perfume particle that gives a good dry fabric odour benefit.

It is also preferred to control the temperature of step (b) in order to obtain perfume particles having a good dry fabric odour performance. Preferably, step (b) is carried out a temperature of less than 50° C., or even less than 20° C. It may be preferred that cooling means such as a water jacket or even liquid nitrogen are used in step (b), this is especially preferred when it is desirable to carry out step (b) at a temperature that is below the ambient temperature.

It may also be preferred to limit the energy condition of step (b) in order to obtain a perfume particle that has a good dry fabric odour performance. Step (b) is preferably done in a low shear mixer, for example a stirred tank.

The third step, step (c), of drying the intermediate mixture to form a perfume particle can be carried out in any suitable drying equipment such a spray-dryer and/or fluid bed dryer. Typically, the intermediate mixture is forced dried (for example, spray-dried or fluid bed dried) and is not simply left to dry by evaporation at ambient conditions. Typically, heat is applied during this drying step. Typically, the intermediate mixture is spray-dried. Preferably, the temperature of the drying step is carefully controlled to prevent the perfume component from vapourising and escaping from the perfume particle, which reduces the perfume particles dry-fabric odour performance. Preferably, the intermediate mixture is spray-dried in a spray-drying tower, and preferably the difference between the inlet air temperature and the outlet air temperature in the spray-drying tower is less than 100° C. This is a smaller temperature difference than is conventionally used in spray-drying laundry detergent components but (as explained above) is preferred in order to prevent the unwanted vapourisation of the volatile PRMs from the perfume component. Typically, the inlet air temperature of the spray-drying tower is from 170° C. to 220° C., and the outlet air temperature of the spray-drying tower is from 80° C. to 110° C. Highly preferred is when the inlet air temperature of the spray-drying tower is from 170° C. to 180° C., and the outlet air temperature of the spray-drying tower is from 100° C. to 105° C. It is also important that a good degree of atomisation of the intermediate material is achieved during the spray-drying process, as this ensures that the perfume particles have the optimal particle size distribution, having good flowability, solubility, stability and dry fabric odour performance. The degree of atomisation can be controlled by carefully controlling the tip speed of the rotary atomiser in the spray-drying tower. Preferably, the rotary atomiser has a tip speed of from 100 ms⁻¹ to 500 ms⁻¹.

It may be preferred that during its processing and storage thereafter, the perfume particle and any intermediate product that is formed during its processing, is kept in an environment having a low relative humidity. Preferably the air immediately surrounding the perfume particle (or intermediate material thereof) is the equal to or lower than, preferably lower than, the equilibrium relative humidity of the perfume particle (or intermediate material thereof). This can be achieved, for example, by placing the perfume particle in air tight containers during storage and/or transport, or by the input of dry and/or conditioned air into the mixing vessels, storage and/or transport containers during the process, transport and/or storage of the perfume particle (or intermediate material thereof).

Perfume particles that are obtained by the above process have a high fabric delivery index and good dry fabric odour performance.

### EXAMPLES

### Example 1

The following perfume accords are suitable for use in the present invention. Amounts given below are by weight of the perfume accord.

### Perfume Accord A

| PRM trade name | PRM chemical name | Amount |
|---|---|---|
| Damascone beta ™ | 2-buten-1-one, 1-(2,6,6-trimethyl-1- | 1% |
| | cyclohexen-1-yl)- | |
| Dynascone 10 ™ | 4-Penten-1-one, 1-(5,5-dimethyl-1- | 5% |
| | cyclohexen-1-yl)- | |
| | Ethyl 2 Methyl Butyrate | 6% |
| Eugenol | 4-hydroxy-3-methoxy-1-allylbenzene | 1% |
| Cyclacet ™ | Tricyclo decenyl acetate | 3% |
| Cyclaprop ™ | Tricyclo decenyl propionate | 6% |
| Ionone beta ™ | 2-(2,6,6-Trimethyl-1-cyclohexen-1-yl)-3- | 8% |
| | buten-2-one | |
| Nectaryl ™ | 2-(2-(4-Methyl-3-cyclohexen-1-yl)propyl) | 50% |
| | cyclopentanone | |
| Triplal ™ | 3-cyclohexene-1-carboxaldehyde, | 10% |
| | dimethyl | |
| Verdox ™ | Ortho tertiary butyl cyclohexanyl acetate | 10% |

Perfume accord A is an example of a fruity perfume accord.

### Perfume Accord B

| PRM trade name | PRM chemical name | Amount |
|---|---|---|
| Ally amyl glycolate ™ | Glycolic acid, 2-pentyloxy:allyl ester | 5% |
| Damascone beta ™ | 2-buten-1-one, 1-(2,6,6-trimethyl-1- | 2% |
| | cyclohexen-1-yl)- | |
| Dynascone 10 ™ | 4-Penten-1-one, 1-(5,5-dimethyl-1- | 5% |
| | cyclohexen-1-yl)- | |
| Hedione ™ | Cyclopentaneacetic acid, 3-oxo-2- | 25% |
| | pentyl-methyl ester | |
| Iso cyclo citral | 3-cyclohexene-1-carboxaldehyde, 2,4,6- | 5% |
| | trimethyl | |
| Lilial ™ | 2-Methyl-3-(4-tert-butylphenyl)propanal | 48% |
| Rose oxide | Methyl iso butenyl tetrahydro pyran | 5% |
| Triplal ™ | 3-cyclohexene-1-carboxaldehyde, | 5% |
| | dimethyl | |

Perfume accord B is an example of a floral green perfume accord.

### Perfume Accord C

| PRM trade name | PRM chemical name | Amount |
|---|---|---|
| Hedione ™ | Cyclopentaneacetic acid, 3-oxo-2-pentyl- | 30% |
| | methyl ester | |
| Isoraldeine 70 ™ | Gamma-methylionone | 30% |
| Dodecanal | Lauric Aldehyde | 1% |
| Lilial ™ | 2-Methyl-3-(4-tert-butylphenyl)propanal | 30% |
| | Methyl Nonyl Acetaldehyde | 1% |
| Triplal ™ | 3-cyclohexene-1-carboxaldehyde, dimethyl | 5% |
| | Undecylenic Aldehyde | 3% |

Perfume accord C is an example of a floral aldehydic perfume accord.

### Example 2

The perfume accords of Example 1 undergo the following process to obtain perfume particles that are suitable for use in the present invention.

Zeolite 13x is passed through a Schugi mixer, wherein the perfume accord is sprayed onto the zeolite 13x to obtain perfume-loaded zeolite 13x comprising 85% zeolite 13x and 15% perfume accord. The Schugi mixer is operated at 2,000 rpm to 4,000 rpm. Liquid nitrogen is used to control the build up of heat that occurs during this perfume-loading step, which is carried out at a temperature of below 40° C.

Water and starch are mixed together to form an aqueous mixture of starch. The perfume-loaded zeolite 13x is added to this aqueous mixture of starch to form an encapsulation mixture comprising 10.5 wt % starch, 24.5 wt % perfume-loaded zeolite 13x, and 65 wt % water. This is carried out in a batch container. The time of this step is less than 20 minutes.

The encapsulation mixture is fed continuously to a buffer tank, from where it is spray dried. The encapsulation mixture is pumped into a Production Minor using a peristaltic pump and then spray dried to obtain perfume particles. The rotary atomiser tip speed was 151.8 m/s (29000 rpm of a 10 cm diameter atomiser). The inlet temperature of the spray-drying tower is 170° C. and the outlet temperature of the spray-drying tower is 105° C.

The particles obtained by this process comprise a perfume component in slow release form and wherein the release kinetics are controlled so as to provide a fabric delivery index for dry versus wet fabrics of at least 0.3.

### Example 3

The perfume particles of example 2 are incorporated into the following solid laundry detergent composition, which are suitable for use in the present invention. Amounts given below are by weight of the composition.

| Ingredient | A | B | C | D | E | F |
|---|---|---|---|---|---|---|
| Sodium linear_{C11-13} | 15% | 18% | 15% | 11% | 10% | 8% |
| alkylbenzene sulphonate | | | | | | |
| R₂N⁺(CH₃)₂(C₂H₄OH), | 0.6% | | 0.5% | 0.6% | | 0.5% |
| wherein R₂ = C₁₂-C₁₄ alkyl | | | | | | |
| group | | | | | | |
| Sodium C₁₂₋₁₈ linear alkyl | | 2.0% | 0.8% | | | |
| sulphate condensed with an | | | | | | |
| average of 3 to 5 moles of | | | | | | |
| ethylene oxide per mole of | | | | | | |
| alkyl sulphate | | | | | | |
| Mid chain methyl branched | | | | 1.4% | | 1.0% |
| sodium C₁₂₋₁₈ linear alkyl | | | | | | |
| sulphate | | | | | | |
| Sodium linear C₁₂₋₁₈ linear | | | | 0.7% | | 0.5% |
| alkyl sulphate | | | | | | |
| Sodium tripolyphoshate | 25% | 30% | 30% | | | |
| (anhydrous weight given) | | | | | | |
| Citric acid | | | | 2.5% | 2.0% | 3.0% |
| Sodium carboxymethyl | 0.3% | 0.2% | | 0.2% | 0.2% | |
| cellulose | | | | | | |
| Hydrophobically modified | | | | 0.8% | 0.7% | 0.5% |
| (e.g. ester modified) cellulose | | | | | | |
| Sodium polyacrylate polymer | | 0.5% | 0.8% | | | |
| having a weight average | | | | | | |
| molecular weight of from | | | | | | |
| 3,000 to 5,000 | | | | | | |
| Copolymer of maleic/acrylic | | | | 1.4% | 1.5% | |
| acid, having a weight average | | | | | | |
| molecular weight of from | | | | | | |
| 50,000 to 90,000, wherein | | | | | | |
| the ratio of maleic to acrylic | | | | | | |
| acid is from 1:3 to 1:4 | | | | | | |
| Sulphated or sulphonated | | 1.5% | 1.0% | | 1.0% | 1.5% |
| bis((C₂H₅O)(C₂H₄O)ₙ)(CH₃)N⁺CₓH₂ₓN⁺(CH₃)bis(C₂H₅O)(C₂H₄O)ₙ), | | | | | | |
| wherein n = from | | | | | | |
| 20 to 30 and x = from 3 to 8 | | | | | | |
| Diethylene triamine | 0.2% | 0.3% | 0.3% | | | |
| pentaacetic acid | | | | | | |
| Diethylene triamine | | | | 0.2% | 0.3% | 0.3% |
| pentaacetic acid | | | | | | |
| Proteolytic enzyme having an | 0.5% | 0.4% | 0.5% | 0.1% | 0.15% | 0.2% |
| enzyme activity of from 15 mg/g | | | | | | |
| to 70 mg/g | | | | | | |
| Amylolytic enzyme having | 0.2% | 0.3% | 0.3% | 0.2% | 0.1% | 0.15% |
| an enzyme activity of from | | | | | | |
| 25 mg/g to 50 mg/g | | | | | | |
| Anhydrous sodium perborate | 5% | 4% | 5% | | | |
| monohydrate | | | | | | |
| Sodium percarbonate | | | | 6% | 8% | 6.5% |
| Magnesium sulphate | | | | 0.4% | 0.3% | 0.3% |
| Nonanoyl oxybenzene | 2% | 1.5% | 1.7% | | | |
| sulphonate | | | | | | |
| Tetraacetylethylenediamine | 0.6% | 0.8% | 0.5% | 1.2% | 1.5% | 1.0% |
| Brightener | 0.1% | 0.1% | 0.1% | 0.04% | 0.03% | 0.04% |
| Sodium carbonate | 25% | 22% | 25% | 28% | 28% | 20% |
| Sodium sulphate | 14% | 14% | 14% | 12% | 15% | 10% |
| Zeolite A | 1% | 1.5% | 2% | 20% | 18% | 22% |
| Sodium silicate (2.0R) | 0.8% | 1% | 1% | | | |
| Crystalline layered silicate | | | | 3% | 3.5% | 4% |
| Photobleach | 0.005% | 0.004% | 0.005% | 0.001% | 0.002% | 0.002% |
| Montmorillonite clay | | | | | | 10% |
| Polyethyleneoxide having a | | | | | | 0.2% |
| weight average molecular | | | | | | |
| weight of from 100,000 to | | | | | | |
| 1,000,000 | | | | | | |
| Perfume particle according to | 3% | 2% | 1% | 3% | 2% | 1% |
| Example 2 | | | | | | |
| Perfume spray-on | | 0.5% | 0.3% | | 0.3% | 0.5% |
| Starch encapsulated perfume | | | 0.2% | | 0.2% | |
| accord | | | | | | |
| Silicone based suds | | | | 0.05% | 0.06% | 0.05% |
| suppressor | | | | | | |
| Miscellaneous and moisture | to | to | to | to | to | to |
| | 100% | 100% | 100% | 100% | 100% | 100% |

### Example 4

The following perfume accord is an example of a spray-on perfume that is illustrative of a perfume component having a fabric delivery index for dry versus wet fabrics of less than 0.1, and which can be used in combination with the perfume particles of Example 2. Amounts given below are by weight of the perfume accord.

| PRM trade name | PRM chemical name | Amount |
|---|---|---|
| Intreleven aldehyde ™ | 10 undecenal | 0.2% |
| Ethyl safranate ™ | Ethyl 2,6,6-trimethyl-1,3- | 2% |
| | cyclohexadiene-1-carboxylate | |
| Keone | | 0.2% |
| Phenyl acetaldehyde | 1-oxo-2-phenylethane | 0.5% |
| Diphenyl oxide | Diphenyl ether | 2.5% |
| Methyl Diantilis ™ | 2-ethoxy-4-methoxymethylphenol | 1.5% |
| Citronellyl acetate | 3,7-dimethyl-6-octen-1-yl acetate | 5% |
| Ionone 100% ™ | 3-buten-2-one,4-(2,6,6-trimethyl-2- | 15% |
| | cyclohexen-1-yl) | |
| Phenyl ethyl alcohol | 2-phenylethylalcohol | 10% |
| Linalool | 3,7-dimethyl-1,6-octadien-3-ol | 15% |
| Vertenex | Para-tertiary-butylcyclohexylacetate | 15% |
| Citronellol | 3,7-dimethyl-6-octen-1-ol | 20% |
| Hexyl salicylate | n-hexyl-ortho-hydroxybenzoate | 13.1% |

This perfume accord is an example of a rose perfume accord.

What is claimed is:

1. A laundry additive composition comprising one or more perfume components in slow release form and wherein the release kinetics are controlled so as to provide a fabric delivery index for dry versus wet fabrics of at least 0.3.

2. A composition according to claim 1, wherein the one or more perfume components has a fabric delivery index of at least 0.5.

3. A composition according to claim 1 additionally comprising at least one other perfume component of a different composition and olfactory character having a fabric delivery index for dry versus wet fabrics of less than 0.1.

4. A composition according to claim 1, wherein the perfume component is encapsulated with a water-soluble or dispersible encapsulating agent.

5. A composition according to claim 1, wherein the perfume component is absorbed on a porous carrier material.

6. A laundry detergent composition comprising the laundry additive composition of claim 1.

7. A laundry detergent composition according to claim 6 comprising from 0 wt % to 26 wt % phosphate.

8. A process for preparing a solid perfume particle suitable for use in laundering, the process comprises the steps of:
a) contacting a perfume component with a porous carrier material, to form a perfume-loaded material; and
b) contacting the perfume-loaded material, with an aqueous solution or dispersion of encapsulating material, to form an intermediate mixture, said step being carried out at a temperature of less than 50° C.; and
c) drying of the intermediate mixture to form a perfume particle,
wherein, the perfume-loaded material is in contact with the aqueous solution or dispersion of encapsulating material for a period of time of from 0.001 minutes to less than 120 minutes prior to drying and wherein, in c), the perfume-loaded material is spray dried in a spray-drying tower, and wherein further, the difference in temperature between the inlet air temperature and the outlet air temperature in the spray-drying tower is less than 80° C.

9. A process according to claim 8, wherein, in step (b), the perfume-loaded material is in contact with the aqueous solution or dispersion of encapsulating material for a period of time of from 0.001 minutes to 20 minutes.

10. A process according to claim 8, wherein step (b) is carried out at a temperature of less than 20° C.

11. A process according to claim 8, wherein, step (b) occurs in a low shear mixer.

12. A perfume particle obtainable by the process of claim 8, wherein the particle has release kinetics such that it provides a fabric delivery index of at least 0.3.

13. A laundry composition comprising a particle according to claim 13.

14. A method of perfuming a fabric, comprising the step of contacting a composition according to claim 1, with a fabric.

15. A method of perfuming a fabric, comprising the step of contacting a perfume particle according to any of claim 4, with a fabric.

16. A method of perfuming a fabric, comprising the step of contacting a composition according to claim 14, with a fabric.

17. A method of perfuming a fabric, comprising the step of contacting a perfume particle according to any of claim 13, with a fabric.

18. A composition according to claim 5, wherein said porous carrier material is an aluminosilicate.
